(19) United States
(12) Patent Application Publication
(10) Pub. No.: US 2023/0046155 A1
(43) Pub. Date: Feb. 16, 2023

(54) DYNAMIC WIDGET PLACEMENT WITHIN AN ARTIFICIAL REALITY DISPLAY

(71) Applicant: Facebook Technologies, LLC, Menlo Park, CA (US)

(72) Inventors: Feiyu Lu, Blacksburg, VA (US); Mark Parent, Toronto (CA); Hiroshi Horii, Redwood, CA (US); Yan Xu, Kirkland, WA (US); Peiqi Tang, Redmond, WA (US)

(21) Appl. No.: 17/747,767

(22) Filed: May 18, 2022

Related U.S. Application Data
(60) Provisional application No. 63/231,940, filed on Aug. 11, 2021.

(51) Int. Cl. G06F 3/04815; G06T 19/00; G06T 7/73; G06T 15/20

(52) U.S. Cl. CPC G06F 3/04815; G06T 19/006; G06T 7/73; G06T 15/20

(57) ABSTRACT

The disclosed computer-implemented method may include (1) identifying a trigger element within a field of view presented by a display element of an artificial reality device, (2) determining a position of the trigger element within the field of view, (3) selecting a position within the field of view for a virtual widget based on the position of the trigger element, and (4) presenting the virtual widget at the selected position via the display element. Various other methods, systems, and computer-readable media are also disclosed.

### CROSS REFERENCE TO RELATED APPLICATION

This application claims the benefit of U.S. Provisional Application No. 63,231/940, filed 11 Aug. 2022, the disclosure of each of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an illustration of exemplary augmented-reality glasses that may be used in connection with embodiments of this disclosure.

FIG. 2 is an illustration of an exemplary virtual-reality headset that may be used in connection with embodiments of this disclosure.

FIG. 3 is a flow diagram of an exemplary method for digital widget placement within an artificial reality display.

FIG. 4 is an illustration of an exemplary system for digital widget placement within an artificial reality display.

FIGS. 5A-5B are illustrations of an augmented reality environment with digital widgets placed within the environment.

FIG. 6 is an illustration of an additional augmented reality environment with digital widgets placed within the environment.

FIGS. 7A-7B are illustrations of an additional augmented reality environment with digital widgets placed within the environment.

FIGS. 8A-8B are illustrations of an augmented reality environment with digital widget icons placed within the environment.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to an artificial reality device (e.g., a virtual and/or augmented reality system) configured to be worn by a user as the user interacts with the real world. The disclosed artificial reality device may include a display element through which the user may see the real world. The display element may additionally be configured to display virtual content such that the virtual content is visually superimposed over the real world within the display element. Because both real-world elements and virtual content may be presented to the user via the display element, there is a risk that poor placement of virtual content within the display element may inhibit the user's interactions with the real world (e.g., by obstructing real-world objects), instead of enhancing the same. In light of this risk, the present disclosure identifies a need for systems and methods for placing a virtual element at a position within a display element of an artificial reality device that is determined based on a position of one or more trigger elements (e.g., objects and/or areas) within the display element. In one example, a computer-implemented method may include (1) identifying a trigger element presented within a display element of an artificial reality device, (2) determining a position of the trigger element within the display element, (3) selecting a position within the display element for a virtual widget based on the position of the trigger element, and (4) presenting the virtual widget at the selected position within the display element.

The disclosed systems may implement this disclosed method in many different use cases. As one specific example, the disclosed systems may identify a readable surface (e.g., a computer screen, a page of a book, etc.) within the field of view presented via a display element of an artificial reality device and, in response, may place one or more virtual widgets within the field of view at one or more positions that are a designated distance and/or direction from the readable surface (e.g., surrounding the readable surface) so as to not interfere with a user's ability to read what is written on the readable surface. In one embodiment, the virtual widgets may be configured to conform to a designated pattern around the readable surface. Similarly, the disclosed systems may identify a stationary object (e.g., a stove) within the field of view presented via a display element of an artificial reality device and, in response, may place one or more virtual widgets (e.g., a virtual timer) within the field of view at a position that is proximate a position of the object (e.g., such that the virtual widget appears to be resting on the object).

In one embodiment, the disclosed systems may identify a peripatetic object (e.g., an arm of a user of an artificial reality device) within the field of view presented via a display element of an artificial reality device and, in response, may place one or more virtual widgets within the field of view at a position that is a designated proximity to the object (e.g., maintaining the relative position of the object to the virtual widget as the object moves). As another specific example, the disclosed systems may, in response to determining that a user wearing an augmented reality device is moving (e.g., walking, running, dancing, or driving), (1) identify a central area within the field of view presented via a display element of the augmented reality device and (2) position one or more virtual widget to a peripheral position outside of (e.g., to the sides of) the central area (e.g., such that the position of the virtual widgets does not obstruct a view of objects that may be in the user's path of movement).

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

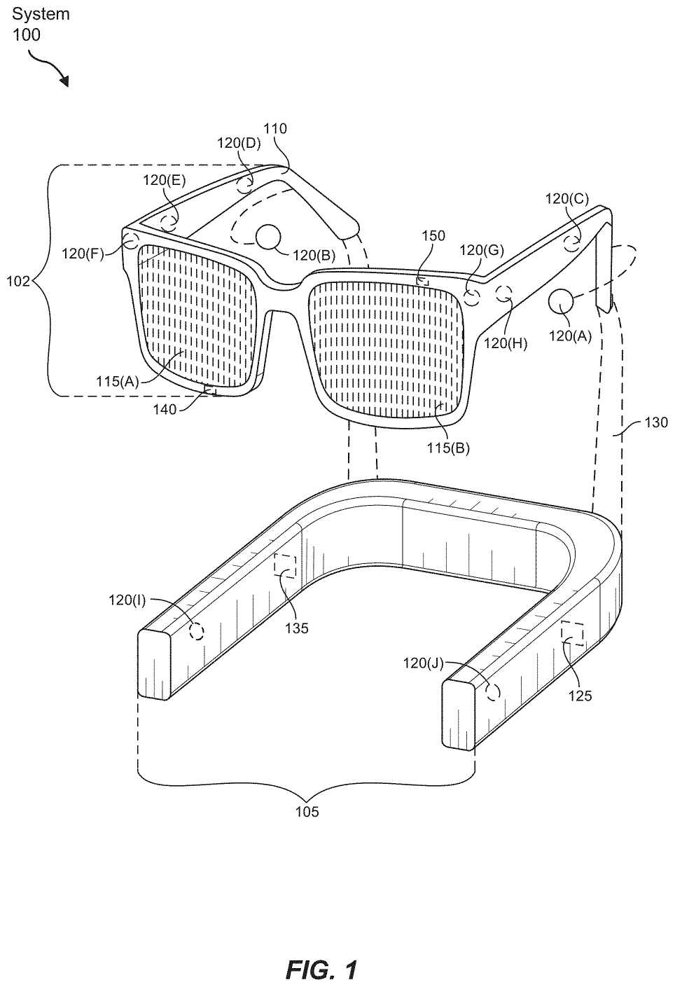

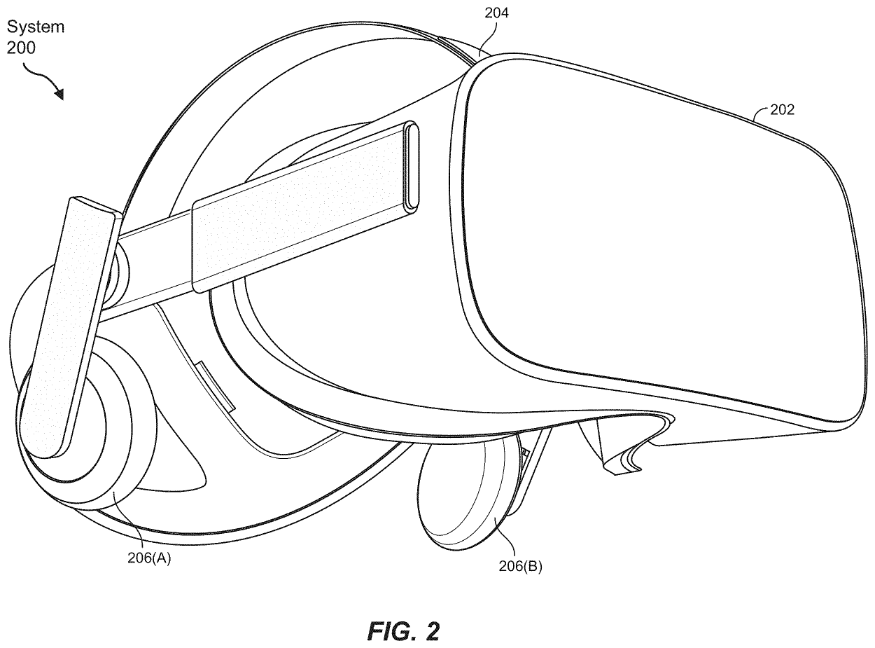

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 100 in FIG. 1) or that visually immerses a user in an artificial reality (such as, e.g., virtual-reality system 200 in FIG. 2). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 1, augmented-reality system 100 may include an eyewear device 102 with a frame 110 configured to hold a left display device 115(A) and a right display device 115(B) in front of a user's eyes. Display devices 115(A) and 115(B) may act together or independently to present an image or series of images to a user. While augmented-reality system 100 includes two displays, embodiments of this disclosure may be implemented in augmented-reality systems with a single NED or more than two NEDs. In some embodiments, augmented-reality system 100 may include one or more sensors, such as sensor 140. Sensor 140 may generate measurement signals in response to motion of augmented-reality system 100 and may be located on substantially any portion of frame 110. Sensor 140 may represent one or more of a variety of different sensing mechanisms, such as a position sensor, an inertial measurement unit (IMU), a depth camera assembly, a structured light emitter and/or detector, or any combination thereof. In some embodiments, augmented-reality system 100 may or may not include sensor 140 or may include more than one sensor. In embodiments in which sensor 140 includes an IMU, the IMU may generate calibration data based on measurement signals from sensor 140. Examples of sensor 140 may include, without limitation, accelerometers, gyroscopes, magnetometers, other suitable types of sensors that detect motion, sensors used for error correction of the IMU, or some combination thereof.

In some examples, augmented-reality system 100 may also include a microphone array with a plurality of acoustic transducers 120(A)-120(J), referred to collectively as acoustic transducers 120. Acoustic transducers 120 may represent transducers that detect air pressure variations induced by sound waves. Each acoustic transducer 120 may be configured to detect sound and convert the detected sound into an electronic format (e.g., an analog or digital format). The microphone array in FIG. 1 may include, for example, ten acoustic transducers: 120(A) and 120(B), which may be designed to be placed inside a corresponding ear of the user, acoustic transducers 120(C), 120(D), 120(E), 120(F), 120(G), and 120(H), which may be positioned at various locations on frame 110, and/or acoustic transducers 120(I) and 120(J), which may be positioned on a corresponding neckband 105. In some embodiments, one or more of acoustic transducers 120(A)-(J) may be used as output transducers (e.g., speakers). For example, acoustic transducers 120(A) and/or 120(B) may be earbuds or any other suitable type of headphone or speaker.

The configuration of acoustic transducers 120 of the microphone array may vary. While augmented-reality system 100 is shown in FIG. 1 as having ten acoustic transducers 120, the number of acoustic transducers 120 may be greater or less than ten. In some embodiments, using higher numbers of acoustic transducers 120 may increase the amount of audio information collected and/or the sensitivity and accuracy of the audio information. In contrast, using a lower number of acoustic transducers 120 may decrease the computing power required by an associated controller 150 to process the collected audio information. In addition, the position of each acoustic transducer 120 of the microphone array may vary. For example, the position of an acoustic transducer 120 may include a defined position on the user, a defined coordinate on frame 110, an orientation associated with each acoustic transducer 120, or some combination thereof.

Acoustic transducers 120(A) and 120(B) may be positioned on different parts of the user's ear, such as behind the pinna, behind the tragus, and/or within the auricle or fossa. Or, there may be additional acoustic transducers 120 on or surrounding the ear in addition to acoustic transducers 120 inside the ear canal. Having an acoustic transducer 120 positioned next to an ear canal of a user may enable the microphone array to collect information on how sounds arrive at the ear canal. By positioning at least two of acoustic transducers 120 on either side of a user's head (e.g., as binaural microphones), augmented-reality system 100 may simulate binaural hearing and capture a 3D stereo sound field around about a user's head. In some embodiments, acoustic transducers 120(A) and 120(B) may be connected to augmented-reality system 100 via a wired connection 130, and in other embodiments acoustic transducers 120(A) and 120(B) may be connected to augmented-reality system 100 via a wireless connection (e.g., a BLUETOOTH connection). In still other embodiments, acoustic transducers 120(A) and 120(B) may not be used at all in conjunction with augmented-reality system 100. Acoustic transducers 120 on frame 110 may be positioned in a variety of different ways, including along the length of the temples, across the bridge, above or below display devices 115(A) and 115(B), or some combination thereof. Acoustic transducers 120 may also be oriented such that the microphone array is able to detect sounds in a wide range of directions surrounding the user wearing the augmented-reality system 100. In some embodiments, an optimization process may be performed during manufacturing of augmented-reality system 100 to determine relative positioning of each acoustic transducer 120 in the microphone array.

In some examples, augmented-reality system 100 may include or be connected to an external device (e.g., a paired device), such as neckband 105. Neckband 105 generally represents any type or form of paired device. Thus, the following discussion of neckband 105 may also apply to various other paired devices, such as charging cases, smart watches, smart phones, wrist bands, other wearable devices, hand-held controllers, tablet computers, laptop computers, other external compute devices, etc. As shown, neckband 105 may be coupled to eyewear device 102 via one or more connectors. The connectors may be wired or wireless and may include electrical and/or non-electrical (e.g., structural) components. In some cases, eyewear device 102 and neckband 105 may operate independently without any wired or wireless connection between them. While FIG. 1 illustrates the components of eyewear device 102 and neckband 105 in example locations on eyewear device 102 and neckband 105, the components may be located elsewhere and/or distributed differently on eyewear device 102 and/or neckband 105. In some embodiments, the components of eyewear device 102 and neckband 105 may be located on one or more additional peripheral devices paired with eyewear device 102, neckband 105, or some combination thereof. Pairing external devices, such as neckband 105, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 100 may be provided by a paired device or shared between a paired device and an eyewear device, thus reducing the weight, heat profile, and form factor of the eyewear device overall while still retaining desired functionality. For example, neckband 105 may allow components that would otherwise be included on an eyewear device to be included in neckband 105 since users may tolerate a heavier weight load on their shoulders than they would tolerate on their heads. Neckband 105 may also have a larger surface area over which to diffuse and disperse heat to the ambient environment. Thus, neckband 105 may allow for greater battery and computation capacity than might otherwise have been possible on a stand-alone eyewear device. Since weight carried in neckband 105 may be less invasive to a user than weight carried in eyewear device 102, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 105 may be communicatively coupled with eyewear device 102 and/or to other devices. These other devices may provide certain functions (e.g., tracking, localizing, depth mapping, processing, storage, etc.) to augmented-reality system 100. In the embodiment of FIG. 1, neckband 105 may include two acoustic transducers (e.g., 120(I) and 120(J)) that are part of the microphone array (or potentially form their own microphone subarray). Neckband 105 may also include a controller 125 and a power source 135.

Acoustic transducers 120(I) and 120(J) of neckband 105 may be configured to detect sound and convert the detected sound into an electronic format (analog or digital). In the embodiment of FIG. 1, acoustic transducers 120(I) and 120(J) may be positioned on neckband 105, thereby increasing the distance between the neckband acoustic transducers 120(I) and 120(J) and other acoustic transducers 120 positioned on eyewear device 102. In some cases, increasing the distance between acoustic transducers 120 of the microphone array may improve the accuracy of beamforming performed via the microphone array. For example, if a sound is detected by acoustic transducers 120(C) and 120(D) and the distance between acoustic transducers 120(C) and 120(D) is greater than, e.g., the distance between acoustic transducers 120(D) and 120(E), the determined source location of the detected sound may be more accurate than if the sound had been detected by acoustic transducers 120(D) and 120(E).

Controller 125 of neckband 105 may process information generated by the sensors on neckband 105 and/or augmented-reality system 100. For example, controller 125 may process information from the microphone array that describes sounds detected by the microphone array. For each detected sound, controller 125 may perform a direction-of-arrival (DOA) estimation to estimate a direction from which the detected sound arrived at the microphone array. As the microphone array detects sounds, controller 125 may populate an audio data set with the information. In embodiments in which augmented-reality system 100 includes an inertial measurement unit, controller 125 may compute all inertial and spatial calculations from the IMU located on eyewear device 102. A connector may convey information between augmented-reality system 100 and neckband 105 and between augmented-reality system 100 and controller 125. The information may be in the form of optical data, electrical data, wireless data, or any other transmittable data form. Moving the processing of information generated by augmented-reality system 100 to neckband 105 may reduce weight and heat in eyewear device 102, making it more comfortable to the user.

Power source 135 in neckband 105 may provide power to eyewear device 102 and/or to neckband 105. Power source 135 may include, without limitation, lithium ion batteries, lithium-polymer batteries, primary lithium batteries, alkaline batteries, or any other form of power storage. In some cases, power source 135 may be a wired power source. Including power source 135 on neckband 105 instead of on eyewear device 102 may help better distribute the weight and heat generated by power source 135.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 200 in FIG. 2, that mostly or completely covers a user's field of view. Virtual-reality system 200 may include a front rigid body 202 and a band 204 shaped to fit around a user's head. Virtual-reality system 200 may also include output audio transducers 206(A) and 206(B). Furthermore, while not shown in FIG. 2, front rigid body 202 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 100 and/or virtual-reality system 200 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 100 and/or virtual-reality system 200 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 100 and/or virtual-reality system 200 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

In some embodiments, one or more objects (e.g., data associated with sensors, and/or activity information) of a computing system may be associated with one or more privacy settings. These objects may be stored on or otherwise associated with any suitable computing system or application, such as, for example, a social-networking system, a client system, a third-party system, a messaging application, a photo-sharing application, a biometric data acquisition application, an artificial-reality application, and/or any other suitable computing system or application. Privacy settings (or “access settings”) for an object may be stored in any suitable manner; such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within an application (such as an artificial-reality application). When privacy settings for an object allow a particular user or other entity to access that object, the object may be described as being “visible” with respect to that user or other entity. As an example, a user of an artificial-reality application may specify privacy settings for a user-profile page that identify a set of users that may access the artificial-reality application information on the user-profile page, thus excluding other users from accessing that information. As another example, an artificial-reality application may store privacy policies/guidelines. The privacy policies/guidelines may specify what information of users may be accessible by which entities and/or by which processes (e.g., internal research, advertising algorithms, machine-learning algorithms), thus ensuring only certain information of the user may be accessed by certain entities or processes. In some embodiments, privacy settings for an object may specify a “blocked list” of users or other entities that should not be allowed to access certain information associated with the object. In some cases, the blocked list may include third-party entities. The blocked list may specify one or more users or entities for which an object is not visible.

Privacy settings associated with an object may specify any suitable granularity of permitted access or denial of access. As an example, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. In some embodiments, different objects of the same type associated with a user may have different privacy settings. In addition, one or more default privacy settings may be set for each object of a particular object-type.

Features from any of the embodiments described herein may be used in combination with one another in accordance with the general principles described herein. These and other embodiments, features, and advantages will be more fully understood upon reading the following detailed description in conjunction with the accompanying drawings and claims.

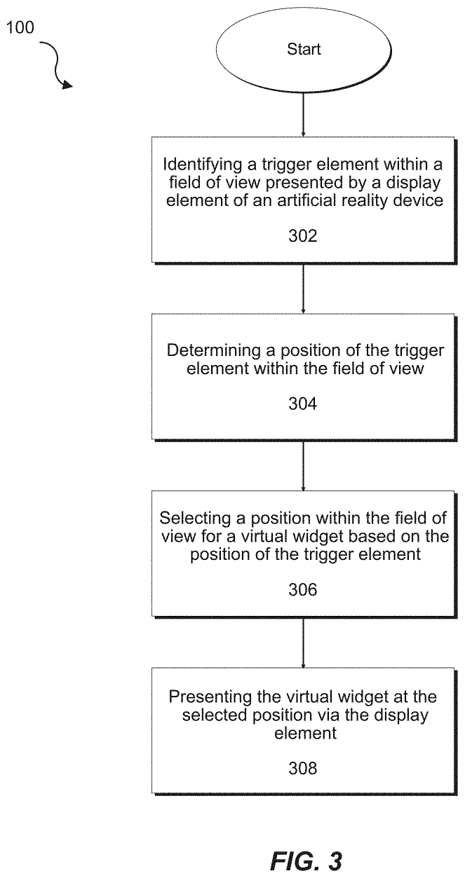

The following will provide, with reference to FIGS. 3-8B, detailed descriptions of computer-implemented methods for placing a virtual element at a position within a display element of an artificial reality device that is determined based on a position of one or more trigger elements (e.g., objects and/or areas) viewable via the display element.

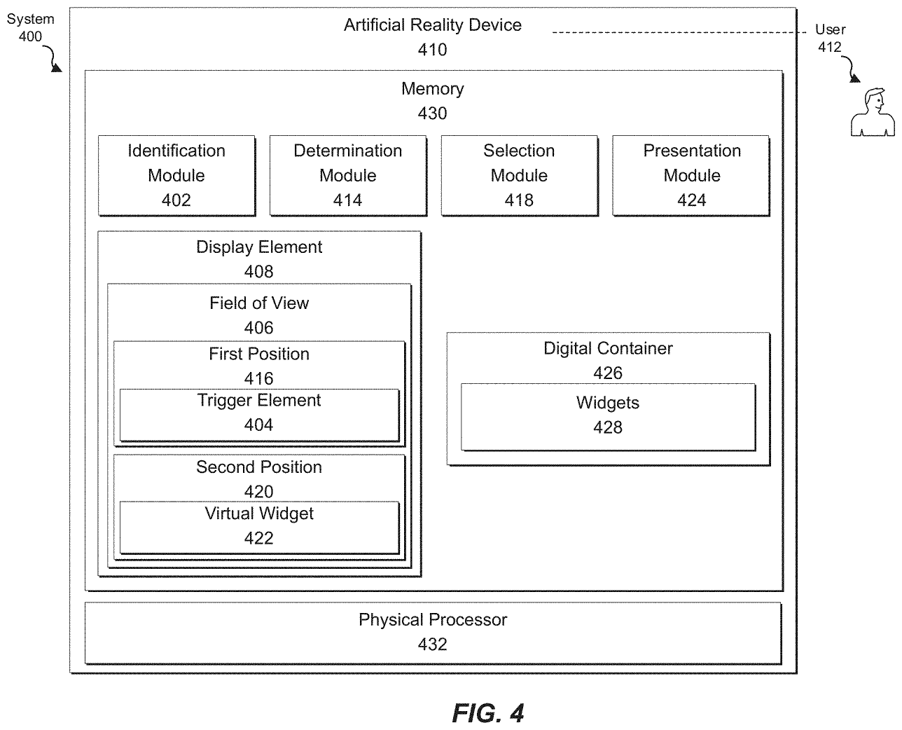

FIG. 3 is a flow diagram of an exemplary computer-implemented method 300 for virtual widget placement. The steps shown in FIG. 3 may be performed by any suitable computer-executable code and/or computing system, including the system(s) illustrated in FIG. 4. In one example, each of the steps shown in FIG. 3 may represent an algorithm whose structure includes and/or is represented by multiple sub-steps, examples of which will be provided in greater detail below. In some examples, the steps may be performed by a computing device. This computing device may represent an artificial reality device, such as artificial reality device 410 illustrated in FIG. 4. Artificial reality device 410 generally represents any type or form of system designed to provide an artificial reality experience to a user, such as one or more of the systems previously described in connection with FIGS. 1-2. Additionally or alternatively, the computing device may be communicatively coupled to an artificial reality device (e.g., a computing device in wired or wireless communication with artificial reality device 410). Each of the steps described in connection with FIG. 3 may be performed on a client device and/or may be performed on a server in communication with a client device.

As illustrated in FIG. 3, at step 302 one or more of the systems described herein may identify a trigger element within a field of view presented by a display element of an artificial reality device. For example, as illustrated in FIG. 4, an identification module 402 may identify a trigger element 404 within a field of view 406 presented by a display element 408 of an artificial reality device 410 of a user 412.

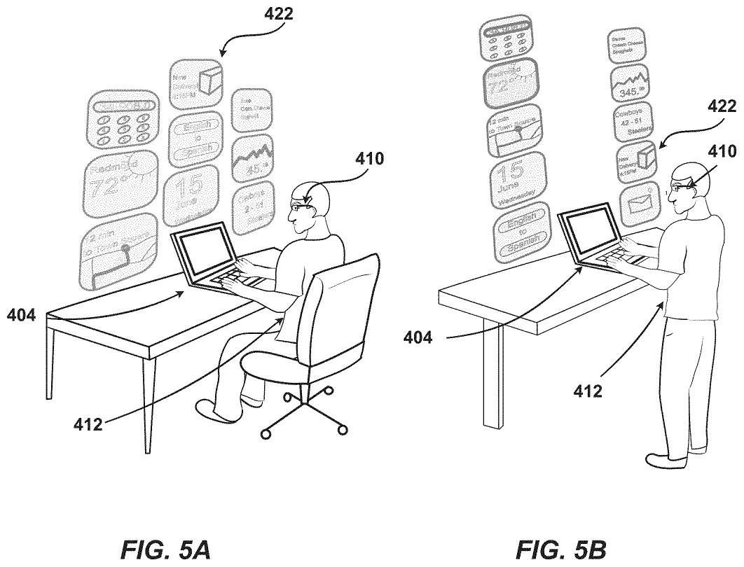

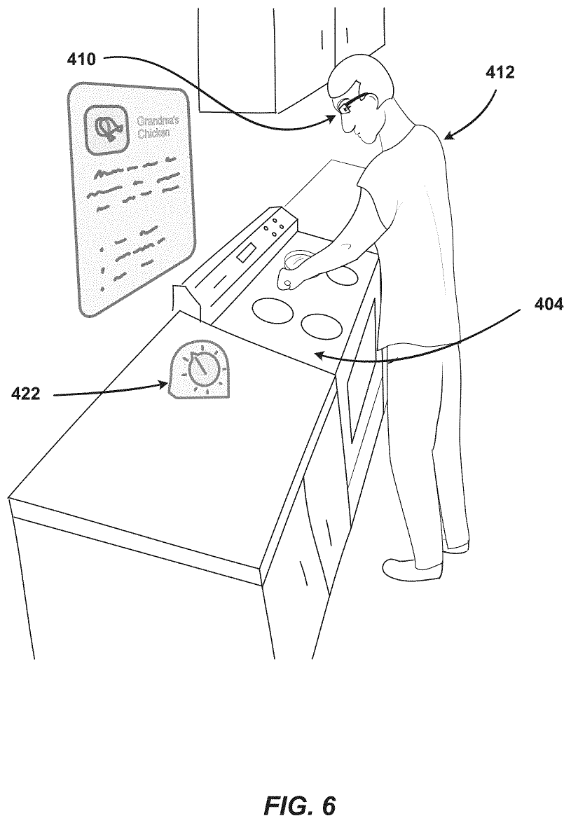

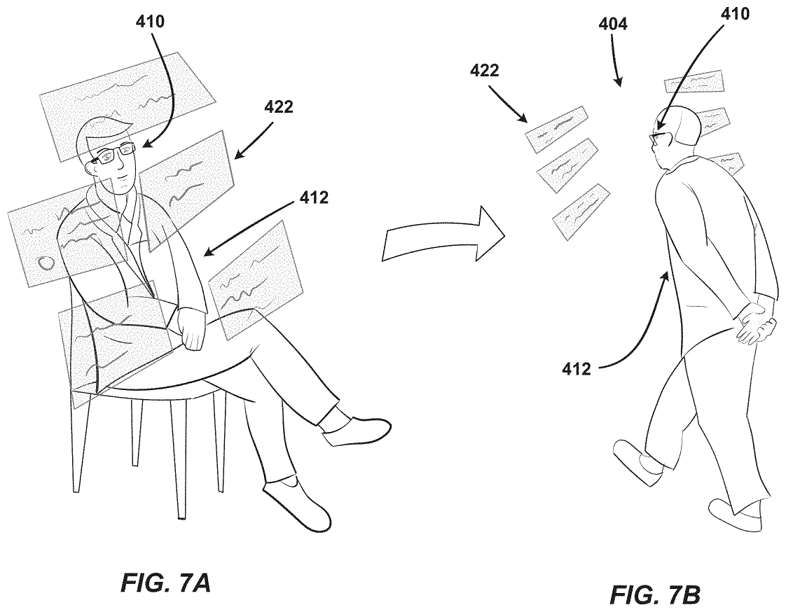

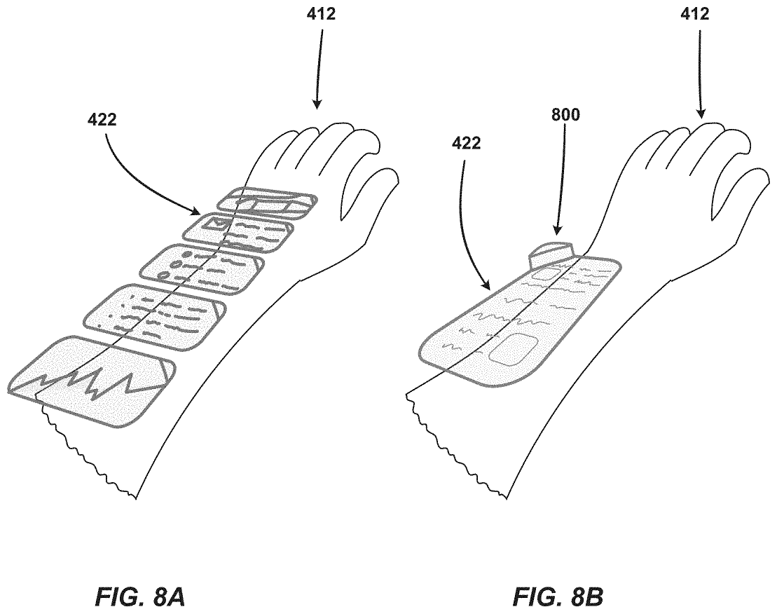

Trigger element 404 generally represents any type or form of element (e.g., object or area) within field of view 406 that may be detected by artificial reality device 410 and displayed via (e.g., seen through) display element 408. Trigger element 404 may represent a real-world element (e.g., in embodiments in which artificial reality device 410 represents an augmented reality device) and/or a virtual element (e.g., in embodiments in which artificial reality device 410 represents an augmented reality device and/or a virtual reality device). As a specific example, trigger element 404 may represent a readable surface area. For example, trigger element 404 may represent a book, a billboard, a computer screen (as illustrated in FIGS. 5A-5B), a cereal box, a map, etc. As another specific example, trigger element 404 may represent a stationary object. For example, trigger element 404 may represent a stove, a chair, a watch, a comb, a sandwich, a building, a bridge, etc. FIG. 6 depicts a specific example in which trigger element 404 represents a counter next to a stove. Additionally or alternatively, trigger element may represent a moving object (e.g., an arm as depicted in FIGS. 8A-8B, a car, etc.). In certain examples, trigger element 404 may represent a spatial area within field of view 406. For example, trigger element 404 may represent a central area within field of view 406, as depicted in FIG. 7B. In such examples, the trigger area may be defined in a variety of ways (e.g., any defined spatial area within field of view 406). As a specific example, field of view 406 may be configured as a grid of nine squares and the central area may be defined as the area corresponding to the three squares stacked vertically in the center of the grid.

In some examples, trigger element 404 may represent an element that was manually designated as a trigger element. In these examples, prior to step 320, trigger element 404 may have been manually designated as a trigger element and identification module 402 may have been programmed to identify the manually designated trigger element when detected within field of view 406 of artificial reality device 410. As a specific example, a specific stove and/or kitchen counter within a kitchen of user 412 (as depicted in FIG. 6) may have been manually designated (e.g., via user input from user 412) as a trigger element and identification module 402 may identify the stove and/or kitchen counter when it appears within field of view 406 in response to its manual designation as a trigger element.

In additional or alternative examples, trigger element 404 may represent an element that is classified as a designated type of element. In these examples, identification module 402 may have been programmed to identify elements classified as the designated type and may identify trigger element 404 as a result of this programming. As a specific example, identification module 402 may have been programmed to identify elements classified as computing screens and may identify trigger element 404 in response to trigger element 404 having been classified as a computing screen.

In some examples, trigger element 404 may represent an element that provides a designated functionality. In these examples, identification module 402 may have been programmed to identify an element that provides the designated functionality and may identify trigger element 404 as a result of this programming. As a specific example, trigger element 404 may represent a paper with text and identification module 402 may have been programmed to identify readable elements that appear within field of view 406 (e.g., letters, words, etc.). Similarly, trigger element 404 may represent an element that includes a designated feature. In these examples, identification module 402 may have been programmed to identify an element that includes the designated feature and may have identified trigger element 404 as a result of this programming. As a specific example, trigger element 404 may represent a stove and identification module 402 may have been programmed to identify objects that are stationary (e.g., that are not moving) within field of view 406.

In certain embodiments, identification module 402 may identify trigger element 404 in response to detecting a trigger activity (e.g., in response to determining that a trigger activity is being performed by user 412 of artificial reality device 410). In some such examples, identification module 402 may operate in conjunction with a policy to detect certain trigger elements in response to determining that a certain trigger activity is being performed. As a specific example, identification module 402 may be configured to detect a certain type of trigger element in response to determining that user 412 is walking, dancing, running, and/or driving. In one such example, the trigger element may represent (1) one or more objects determined to be a potential obstacle to the trigger activity (e.g., a box positioned as an obstacle in the direction in which user 412 is moving) and/or (2) a designated area of field of view 406 (e.g., a central area such as the area depicted as trigger element 404 in FIG. 7B). Turning to FIGS. 7A-7B as a specific example of an element becoming a trigger element in response to a trigger activity, in FIG. 7A, in which user 412 is seated, the central area of field of view 406 may not be identified as a trigger element. However, when user 412 begins walking (as depicted in FIG. 7B), the central area of field of view 406 may be identified as a trigger element.

Prior to identification module 402 identifying trigger element 404 (e.g., based on a policy to identify trigger element 404 specifically and/or a policy to identify elements with a feature and/or functionality associated with trigger element 404), a labeling module may have detected and classified trigger element 404. The labeling module may detect and classify elements, such as trigger element 404, using a variety of technologies. In some embodiments, the labeling module may partition a digital image of field of view 406 by associating each pixel within the digital image with a class label (e.g., a tree, a child, user 412's keys, etc.). In some examples, the labeling module may rely on manually inputted labels. Additionally or alternatively, the labeling module may rely on a deep learning network. In one such example, the labeling module may include an encoder network a decoder network. The encoder network may represent a pre-trained classification network. The decoder network may semantically project the features learned by the encoder network to the pixel space of the field of view 406 to elements such as trigger element 404. In this example, the decoder network may utilize a variety of approaches to classify elements (e.g., a region-based approach, a fully convolutional network (FCN) approach, etc.). The elements classified by the labeling module may then, in some examples, be used as input to identification module 402, which may be configured to identify certain specific elements and/or types of elements as described above.

Returning to FIG. 3, at step 304, one or more of the systems described herein may determine a position of the trigger element within the field of view. For example, as illustrated in FIG. 4, a determination module 414 may determine a position of trigger element 404 (i.e., first position 416) within field of view 406 (e.g., a pixel or set of pixel coordinates within a digital image of field of view 406). Then, at step 306, one or more of the systems described herein may select a position within the field of view for a virtual widget based on the position of the trigger element. For example, as illustrated in FIG. 4, a selection module 418 may select a position (e.g., a pixel or set of pixel coordinates) within field of view 406 (i.e., a second position 420) for a virtual widget 422 based on the position of trigger element 404 (i.e., first position 416).

Virtual widget 422 generally represents any type or form of application, with one or more virtual components, provided by artificial reality device 410. In some examples, virtual widget 422 may include virtual content (e.g., information) that may be displayed via display element 408 of artificial reality device 410. In these examples, virtual widget 422 may include and/or be represented by a graphic, an image, and/or text presented within display element 408 (e.g., superimposed over the real-world objects being observed by user 412 through display element 408). In some examples, virtual widget 422 may provide a functionality. Additionally or alternatively, virtual widget 422 may be manipulated by user 412. In these examples, virtual widget 422 may be manipulated via a variety of user input (e.g., a physical tapping and/or clicking of artificial reality device 410, gesture-based input, eye-gaze and/or eye-blinking input, etc.). Specific examples of virtual widget 422 may include, without limitation, a calendar widget, a weather widget, a clock widget, a tabletop widget, an email widget, a recipe widget, a social media widget, a stocks widget, a news widget, a virtual computing screen widget, a virtual timer widget, virtual text, a readable surface widget, etc.

In some examples, virtual widget 422 may be in use (e.g., open with content displayed via display element 408) prior to the identification of trigger element 404. In these examples, a placement of virtual widget 422 may change (i.e., to second position 420) in response to the identification of trigger element 404. Turning to FIGS. 7A-7B as a specific example, user 412 may be looking at stock information, from a virtual stock widget, which may be displayed within a central area of field of view 406 via display element 408 while user 412 is seated (as depicted in FIG. 7A). Then, user 412 may begin walking. In response to determining that user 412 is walking (i.e., in response to detecting a triggering event), identification module 402 may identify a central area within field of view 406 (e.g., trigger element 404) and may move the stock information to an area outside of the central area (e.g., based on a policy to not obstruct the user's walking path with virtual content when the user is walking).

Prior to (and/or as part of) selecting a position for virtual widget 422, selection module 418 may select virtual widget 422 for presenting within display element 408 (e.g., in examples in which virtual widget 422 is not in use prior to the identification of trigger element 404). Selection module 418 may select virtual widget 422 for presenting in response to a variety of triggers. In some examples, selection module 418 may select virtual widget 422 for presenting in response to identifying (e.g., detecting) trigger element 404. In one such example, selection module 418 may operate in conjunction with a policy to present virtual widget 422 in response to identifying a type of object corresponding to trigger element 404 (e.g., an object with a feature and/or functionality corresponding to trigger element 404) and/or a policy to present virtual widget 422 in response to identifying trigger element 404 specifically.

As a specific example, selection module 418 may select a virtual timer widget (e.g., as depicted in FIG. 6) for presenting in response to identifying a stove based on a policy to select the virtual timer for presenting any time that a stove is detected within field of view 406. As another specific example, selection module 418 may select a notepad widget in response to identifying user 412's office desk based on a policy to select the notepad widget for presenting any time user 412's office desk is detected within field of view 406.

In some examples, a policy may have an additional triggering criterion for selecting virtual widget 422 for presenting (e.g., in addition to the identification of trigger element 404). Returning to the example of the notepad widget on the office desk, the policy to select the notepad widget for presenting any time user 412's office desk is detected within field of view 406 may specify to select the notepad for presenting only between certain hours (e.g., only between business hours). In additional or alternative embodiments, selection module 418 may select virtual widget 422 for presenting in response to identifying an environment of user 412 (e.g., user 412's kitchen, user 412's office, a car, the outdoors, the Grand Canyon, etc.) and/or an activity being performed by user 412 (e.g., reading, cooking, running, driving, etc.). As a specific example, selection module 418 may select a virtual timer widget for presenting above a coffee machine in field of view 406 in response to determining that user 412 is preparing coffee. As another specific example, selection module 418 may select a virtual list of ingredients in a recipe (e.g., from a recipe widget) for presenting in response to determining that user 412 has opened a refrigerator (e.g., looking for ingredients) and/or is at the stove (e.g., as illustrated in FIG. 6). As another specific example, selection module 418 may select a calendar widget for presenting on top of an office desk in response to determining that user 412 is sitting at the office desk. As another specific example, selection module 418 may select a virtual weather widget in response to determining that user 412 has entered user 412's closet. As another specific example, selection module 418 may select a virtual heart monitor widget in response to determining that user 412 is running.

In some embodiments, selection module 418 may select virtual widget 422 for presenting in response to receiving user input to select virtual widget 422. In some such embodiments, the user input may directly request the selection of virtual widget 422. For example, the user input may select an icon associated with virtual widget 422 (e.g., from a collection of icons displayed within display element 408 as depicted in FIG. 8A) via tapping, clicking, gesture, and/or eye blinking and/or gazing input. In other examples, the user input may indirectly request the selection of virtual widget 422. For example, the user input may represent a vocal question and/or command the response to which includes the selection of virtual widget 422. As a specific example, virtual widget 422 may represent a recipe widget and selection module 418 may select virtual widget 422 in response to receiving a vocal command from user 412 that vocalizes “What are the ingredients for the recipe I was looking at earlier?”

Selection module 418 may select a position for virtual widget 422 (i.e., second position 420) in a variety of ways. In some examples, selection module 418 may select, for second position 420, a position that is a designated distance from first position 416 (i.e., the position of trigger element 404). As a specific example, in examples in which trigger element 404 represents a readable surface (e.g., as illustrated in FIGS. 5A and 5B), selection module 418 may select a position that is a designated distance from the readable surface such that virtual widget 422 does not obstruct the view of the readable surface within display element 408. Additionally or alternatively, selection module 418 may select, for second position 420, a position that is a designated direction from first position 416. For example (e.g., in examples in which trigger element 404 represents a stationary object such as a table), selection module 418 may select position that is (1) superior to the position of trigger element 404 and (2) a designated distance from trigger element 404 such that virtual widget 422 appears to be resting on top of trigger element 404 within field of view 406. Turning to FIG. 6 as a specific example, trigger element 404 may represent a stove and/or a countertop next to a stove (e.g., detected within user 412's kitchen), virtual widget 422 may represent a virtual kitchen timer, and selection module 418 may be configured to select a position for the virtual kitchen timer that gives the appearance that the virtual kitchen timer is resting on the stove and/or the countertop.

As another specific example, in examples in which virtual widget 422 represents an object determined to be a potential obstacle to a trigger activity (e.g., walking, dancing, running, driving, etc.), selection module 418 may be configured to select a position for virtual widget 422 that is a predetermined distance and/or direction from an area (e.g., a central area) within field of view 406. For example, selection module 418 may be configured to select a position for virtual widget 422 that is a predetermined distance and/or direction from a designated central area (e.g., to not hinder and/or make unsafe a trigger activity such as walking, dancing, running, driving, etc.). In examples in which trigger element 404 represents a static object and/or a static area, the determined position for virtual widget 422 may also be static. In examples in which trigger element 404 represents a peripatetic object and/or area, the determined position for virtual widget 422 may be dynamic (e.g., the relational position of virtual widget 422 to trigger element 404 may be fixed such that the absolute position of virtual widget 422 moves as trigger element 404 moves but the position of virtual widget 422 relative to trigger element 404 does not move), as will be discussed in connection with step 308.

Returning to FIG. 3, at step 308, one or more of the systems described herein may present the virtual widget at the selected position via the display element (e.g., snapping the virtual widget into place at the selected position). For example, as illustrated in FIG. 4, a presentation module 424 may present virtual widget 422 at the selected position (i.e., second position 420) via display element 408. In some examples, identification module 402 may detect a change in the position of trigger element 404 within field of view 406. This change may occur either because trigger element 404 has moved or because user 412 has moved (thereby shifting field of view 406). In these examples, presentation module 424 may change the position (i.e., second position 420) of virtual widget 422 such that (1) the position of virtual widget 422 within field of view 406 changes but (2) the position of virtual widget 422 relative to trigger element 404 stays the same.

In addition to automatically selecting a position for virtual widget 422, in some examples the disclosed systems and methods may enable manual positioning of virtual widget 422 via user input. In one example, a pinch gesture may enable grabbing virtual widget 422 and dropping virtual widget 422 in a new location (i.e., “drag-and-drop positioning”). In another example, touch input to a button may trigger virtual widget 422 to follow a user as the user moves through space (i.e., “tag-along positioning”). In this example, virtual widget 422 may become display-referenced in response to artificial reality device 410 receiving the touch input. This user-following may terminate in response to additional touch input to a button and/or user dragging input. In another example, a user gesture (e.g., a user showing his or her left-hand palm to the front camera of a headset) could trigger the display of a home menu. In this example, user tapping input to an icon associated with virtual widget 422, displayed within the home menu, may trigger virtual widget 422 to not be displayed or to be displayed in a nonactive position (e.g., to the side of the screen, to a designated side of a user hand, etc.).

In certain examples, the disclosed systems and methods may enable user 412 to add virtual widgets to a user-curated digital container 426 for virtual widgets 428. In these examples, presentation module 424 may present virtual widget 422 at least in part in response to determining that virtual widget 422 has been added to user-curated digital container 426. In some such examples, virtual widgets 428 of digital container 426 (e.g., an icon of a virtual widget) may be presented in a designated area (e.g., a non-central designated area) within field of view 406. For example, virtual widgets 428 of digital container 426 may be displayed in a designated corner of field of view 406. In some embodiments, an icon (e.g., a low level-of-detail icon) for each widget included within digital container 426 may be positioned within field of view 406 over a certain body part of user 412 such as a forearm or a wrist of user 412 (e.g., as if included in a wrist-pack and/or forearm-pack), as illustrated in FIG. 8A. (In this example, an icon may be expanded within digital container to show full content and/or a full functionality of a corresponding virtual widget in response to user selection, as shown in FIG. 8B, and collapsed by user input such as user input to a minimize element 800 as depicted in FIG. 8B).

In one embodiment in which virtual widgets are stored in a digital container, each time that user 412 moves away from a current location, each widget may automatically be removed from its current position within field of view 406 and may be attached, in the form of an icon, to the digital container (e.g., displayed in the designated corner and/or over the designated body part of user 412). Additionally or alternatively, user 412 may be enabled to add widgets to the digital container (e.g., “packing a virtual wrist-pack”) prior to leaving a current location (e.g., prior to leaving a room). When user 412 arrives to a new location, widgets may, in some examples, automatically be placed in positions triggered by the objects detected in the new location and/or detected behaviors of the user. Additionally or alternatively, having widgets in the digital container may enable user 214 to easily access (e.g., “pull”) a relevant virtual widget from the digital container to view at the new location.

In some examples, instead of display an icon of each virtual widget included in digital container 426 (e.g., in a designated corner and/or over the designated body part of user 412), the disclosed systems and methods may automatically select a designated subset of virtual widgets (e.g., three virtual widgets) for which to include an icon in the digital container display. In these examples, the disclosed systems and methods may select which virtual widgets to include in the display (e.g., in the designated corner and/or on the body part) based on the objects detected in the user's location and/or based on detected behaviors of the user.

As described above, the disclosed systems and methods provide interfaces for artificial reality displays that may adapt to contextual changes as people move in space. This stands in contrast to artificial reality displays configured to stay at a fixed location until being manually moved or re-instantiated by a user. An adaptive display improves an artificial reality computing device by removing the burden of user interface transition from the user to the device. The disclosed adaptive display may, in some examples, be configured with different levels of automation and/or controllability (e.g., low-effort manual, semi-automatic, and/or fully automatic), enabling a balance of automation and controllability. In some examples, imperfect contextual awareness may be simulated by introducing prediction errors with different costs to correct them during a training phase.

An artificial reality device (e.g., augmented reality glasses) enables users to interact with their everyday physical world with digital augmentation. However, as the user carries out different tasks throughout the day, the user's information needs change on-the-go. Instead of relying primarily or exclusively on a user's effort to find and open applications with the information needed at a given time, the disclosed systems and methods may predict the information needed by a user at a given time and surface corresponding functions based on one or more contextual triggers. Leveraging the prediction and automation capabilities of artificial reality systems, the instant application provides mechanisms to spatially transit artificial reality user interfaces as people move in space. Additionally, the disclosed systems and methods may fully or partially automate the placement of artificial reality elements within an artificial reality display (based on contextual triggers).

### EXAMPLE EMBODIMENTS

Example 1: A computer-implemented method may include (1) identifying a trigger element within a field of view presented by a display element of an artificial reality device, determining a position of the trigger element within the field of view, selecting a position within the field of view for a virtual widget based on the position of the trigger element, presenting the virtual widget at the selected position via the display element.

Example 2: The computer-implemented method of example 1, where selecting the position for the virtual widget includes selecting a position that is a designated distance from the trigger element.

Example 3: The computer-implemented method of examples 1-2, where selecting the position for the virtual widget includes selecting a position that is a designated direction relative to the trigger element.

Example 4: The computer-implemented method of examples 1-3, where the method further includes (1) detecting a change in the position of the trigger element within the field of view and (2) changing the position of the virtual widget such that (i) the position of the virtual widget within the field of view changes but (ii) the position of the virtual widget relative to the trigger element remains the same.

Example 5: The computer-implemented method of examples 1-4, where identifying the trigger element includes identifying an element manually designated as a trigger element, an element that provides a designated functionality, and/or an element that includes a designated featured.

Example 6: The computer-implemented method of examples 1-5, where (1) the trigger element includes and/or represents a readable surface and (2) selecting the position for the virtual widget within the display element includes selecting a position that is a designated distance from the readable surface such that the virtual widget does not obstruct a view of the readable surface within the display element.

Example 7: The computer-implemented method of example 6, where the readable surface includes and/or represents a computer screen.

Example 8: The computer-implemented method of example 7, where (1) the trigger element includes and/or represents a stationary object and (2) selecting the position for the virtual widget within the field of view includes selecting a position that is (i) superior to the position of the trigger element and (ii) a designated distance from the trigger element such that the virtual widget appears to be resting on top of the trigger element within the field of view presented by the display element.

Example 9: The computer-implemented method of example 8, where (1) the virtual widget includes and/or represents a virtual kitchen timer and (2) the trigger element includes and/or represents a stove.

Example 10: The computer-implemented method of examples 1-9, where identifying the trigger element includes identifying the trigger element in response to determining that a trigger activity is being performed by a user of the artificial reality device.

Example 11: The computer-implemented method of example 10, where (1) the trigger activity includes and/or represents at least one of walking, dancing, running, or driving, (2) the trigger element includes and/or represents (i) one or more objects determined to be a potential obstacle to the trigger activity and/or (ii) a designated central area of the field of view, and (3) selecting the position for the virtual widget includes (i) selecting a position that is at least one of a predetermined distance or a predetermined direction from the one or more objects and/or (ii) selecting a position that is at least one of a predetermined distance or a predetermined direction from the designated central area.

Example 12: The computer-implemented method of examples 1-11, where selecting the position within the field of view includes selecting the virtual widget for presenting via the display element in response to identifying the trigger element, an environment of a user of the artificial reality device, and/or an activity being performed by the user of the artificial reality device.

Example 13: The computer-implemented method of example 12, where selecting the position within the field of view includes selecting the virtual widget for presenting the virtual widget in response to identifying the trigger element includes presenting via the display element based on (1) a policy to present the virtual widget in response to identifying a type of object corresponding to the trigger element and/or (2) a policy to present the virtual widget in response to identifying the trigger element.

Example 14: The computer-implemented method of examples 1-13, where the computer-implemented method further includes, prior to identifying the trigger element, adding the virtual widget to a user-curated digital container for virtual widgets, where presenting the virtual widget includes presenting the virtual widget in response to determining that the virtual widget has been added to the user-curated digital container.

Example 15: A system for implementing the above-described method may include at least one physical processor and physical memory that includes computer-executable instructions that, when executed by the physical processor, cause the physical processor to (1) identify a trigger element within a field of view presented by a display element of an artificial reality device, (2) determine a position of the trigger element within the field of view, (3) select a position within the field of view for a virtual widget based on the position of the trigger element, and (4) present the virtual widget at the selected position via the display element.

Example 16: The system of example 15, where selecting the position for the virtual widget includes selecting a position that is a designated direction relative to the trigger element.

Example 17: The system of examples 15-16, where selecting the position for the virtual widget includes selecting a position that is a designated direction relative to the trigger element.

Example 18: The system of examples 15-17, where (1) the trigger element includes and/or represents a readable surface and (2) selecting the position for the virtual widget within the display element includes and/or represents selecting a position that is a designated distance from the readable surface such that the virtual widget does not obstruct a view of the readable surface within the display element.

Example 19: The system of examples 15-18, where (1) the trigger element includes and/or represents a stationary object and (2) selecting the position for the virtual widget within the field of view includes selecting a position that is (i) superior to the position of the trigger element and (ii) a designated distance from the trigger element such that the virtual widget appears to be resting on top of the trigger element within the field of view presented by the display element.

Example 20: A non-transitory computer-readable medium may include one or more computer-readable instructions that, when executed by at least one processor of a computing device, cause the computing device to (1) identify a trigger element within a field of view presented by a display element of an artificial reality device, (2) determine a position of the trigger element within the field of view, (3) select a position within the field of view for a virtual widget based on the position of the trigger element, and (4) present the virtual widget at the selected position via the display element.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device (e.g., memory 430 in FIG. 4) and at least one physical processor (e.g., physical processor 432 in FIG. 4).

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive visual input to be transformed, transform the visual input to a digital representation of the visual input, and use the result of the transformation to identify a position for a virtual widget within a digital display. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A computer-implemented method comprising:
identifying a trigger element within a field of view presented by a display element of an artificial reality device;
determining a position of the trigger element within the field of view;
selecting a position within the field of view for a virtual widget based on the position of the trigger element; and
presenting the virtual widget at the selected position via the display element.

2. The computer-implemented method of claim 1, wherein selecting the position for the virtual widget comprises selecting a position that is a designated distance from the trigger element.

3. The computer-implemented method of claim 1, wherein selecting the position for the virtual widget comprises selecting a position that is a designated direction relative to the trigger element.

4. The computer-implemented method of claim 1, further comprising:
detecting a change in the position of the trigger element within the field of view; and
changing the position of the virtual widget such that (1) the position of the virtual widget within the field of view changes but (2) the position of the virtual widget relative to the trigger element remains the same.

5. The computer-implemented method of claim 1, wherein identifying the trigger element comprises identifying at least one of:
an element manually designated as a trigger element;
an element that provides a designated functionality; or
an element that includes a designated featured.

6. The computer-implemented method of claim 1, wherein:
the trigger element comprises a readable surface; and
selecting the position for the virtual widget within the display element comprises selecting a position that is a designated distance from the readable surface such that the virtual widget does not obstruct a view of the readable surface within the display element.

7. The computer-implemented method of claim 6, wherein the readable surface comprises a computer screen.

8. The computer-implemented method of claim 1, wherein:
the trigger element comprises a stationary object; and
selecting the position for the virtual widget within the field of view comprises selecting a position that is (1) superior to the position of the trigger element and (2) a designated distance from the trigger element such that the virtual widget appears to be resting on top of the trigger element within the field of view presented by the display element.

9. The computer-implemented method of claim 8, wherein (1) the virtual widget comprises a virtual kitchen timer and (2) the trigger element comprises a stove.

10. The computer-implemented method of claim 1, wherein identifying the trigger element comprises identifying the trigger element in response to determining that a trigger activity is being performed by a user of the artificial reality device.

11. The computer-implemented method of claim 10, wherein:
the trigger activity comprises at least one of walking, dancing, running, or driving;
the trigger element comprises at least one of (1) one or more objects determined to be a potential obstacle to the trigger activity or (2) a designated central area of the field of view; and
selecting the position for the virtual widget comprises at least one of (1) selecting a position that is at least one of a predetermined distance or a predetermined direction from the one or more objects or (2) selecting a position that is at least one of a predetermined distance or a predetermined direction from the designated central area.

12. The computer-implemented method of claim 1, wherein selecting the position for the virtual widget within the field of view comprises selecting the virtual widget for presenting via the display element in response to identifying at least one of the trigger element, an environment of a user of the artificial reality device, or an activity being performed by the user of the artificial reality device.

13. The computer-implemented method of claim 12, wherein selecting the virtual widget for presenting via the display element comprises selecting the virtual widget based on at least one of:
a policy to present the virtual widget in response to identifying a type of object corresponding to the trigger element; or
a policy to present the virtual widget in response to identifying the trigger element.

14. The computer-implemented method of claim 1, further comprising, prior to identifying the trigger element, adding the virtual widget to a user-curated digital container for virtual widgets, wherein presenting the virtual widget comprises presenting the virtual widget in response to determining that the virtual widget has been added to the user-curated digital container.

15. A system comprising:
at least one physical processor; and
physical memory comprising computer-executable instructions that, when executed by the physical processor, cause the physical processor to:
identify a trigger element within a field of view presented by a display element of an artificial reality device;
determine a position of the trigger element within the field of view;
select a position within the field of view for a virtual widget based on the position of the trigger element; and
present the virtual widget at the selected position via the display element.

16. The system of claim 15, wherein selecting the position for the virtual widget comprises selecting a position that is a designated distance from the trigger element.

17. The system of claim 15, wherein selecting the position for the virtual widget comprises selecting a position that is a designated direction relative to the trigger element.

18. The system of claim 15, wherein:
the trigger element comprises a readable surface; and
selecting the position for the virtual widget within the display element comprises selecting a position that is a designated distance from the readable surface such that the virtual widget does not obstruct a view of the readable surface within the display element.

19. The system of claim 15, wherein:
the trigger element comprises a stationary object; and
selecting the position for the virtual widget within the field of view comprises selecting a position that is (1) superior to the position of the trigger element and (2) a designated distance from the trigger element such that the virtual widget appears to be resting on top of the trigger element within the field of view presented by the display element.

20. A non-transitory computer-readable medium comprising one or more computer-readable instructions that, when executed by at least one processor of a computing device, cause the computing device to:
identify a trigger element within a field of view presented by a display element of an artificial reality device;
determine a position of the trigger element within the field of view;
select a position within the field of view for a virtual widget based on the position of the trigger element; and
present the virtual widget at the selected position via the display element.
